(19) United States
(12) Patent Application Publication
(10) Pub. No.: US 2025/0272712 A1
(43) Pub. Date: Aug. 28, 2025

(54) ADVERTISING TECHNOLOGY MONITORING PLATFORM

(71) Applicant: InfoTrust, LLC, Blue Ash, OH (US)

(72) Inventors: Alexander Yastrebenetsky, Loveland, OH (US); Michael Loban, Cincinnati, OH (US); David Elig, Cincinnati, OH (US); Christopher Breneman, West Chester, OH (US); Nena Untung, Galena, OH (US); Andrew Bengel, Cincinnati, OH (US)

(21) Appl. No.: 19/059,619

(22) Filed: Feb. 21, 2025

Related U.S. Application Data
(60) Provisional application No. 63/557,276, filed on Feb. 23, 2024.

(51) Int. Cl. G06Q 30/0242

(52) U.S. Cl. CPC G06Q 30/0244

(57) ABSTRACT

Embodiments include methods and systems for monitoring whether a company's website(s) comply with different laws (such as privacy laws), desired settings, settings related to marketing campaigns, or other desired parameters or settings for a company's website(s). For companies to extract the most value from their websites, they want to ensure legal compliance, and also compliance with marketing partners such as Google Analytics or others, so that the largest amount of data, and most accurate data, is collected and tracked across various websites and web pages.

### CROSS REFERENCE TO RELATED INFORMATION

This application claims the benefit of U.S. priority application No. 63/557,276 filed on Feb. 23, 2024, titled “Advertising Technology Monitoring Platform,” the contents of which are hereby incorporated herein in its entirety.

### TECHNICAL FIELD

The present disclosure generally relates to the technical field of website advertising code maintenance and auditing.

### BACKGROUND

Virtually every company today manages a website. Especially for bigger companies, running a website means operating multiple versions of the same website. A single “website” may need to be displayed differently for various audiences and may need to comply with different regulations. A website for CompanyX, for example, may actually have many versions, e.g., an English language version, a Spanish language version, a Spanish language version for Mexico compliant with Mexican privacy laws, a Spanish language version for California compliant with US and California privacy laws, etc. A single website may have dozens of versions and it is difficult to manage each version and maintain consistent user experience, data collection, and legal compliance across all website versions. Companies also attempt to track a variety of data across marketing campaigns, which may involve advertisements, tags, and other functionalities implemented across multiple websites. Important data can include page views, sales conversions, amount of contact data collected, and more. It can be difficult to ensure that marketing campaigns are implemented correctly across multiple websites, for different regions or countries, and across platforms run by separate marketing partners.

### SUMMARY

One embodiment under the present disclosure comprises a computer-implemented method for monitoring one or more websites. The method includes: receiving one or more desired settings for one or more digital marketing campaigns; receiving one or more current digital marketing campaign settings for the one or more websites; comparing the one or more current settings with the one or more desired settings; and presenting the comparison to a user via a user interface.

Another possible embodiment comprises an apparatus for monitoring one or more websites. The apparatus comprises processing circuitry; and a memory. The memory can be implemented with instructions executable by the processing circuitry whereby the apparatus is operative to: receiving one or more desired settings for one or more digital marketing campaigns; receiving one or more current digital marketing campaigns settings for the one or more websites; comparing the one or more current settings with the one or more desired settings; and presenting the comparison to a user via a user interface.

Another possible method embodiment under the present disclosure is a computer-implemented method for training a ML model for improving website performance. The method includes obtaining a dataset of website metrics; training the ML model using the dataset of website metrics, thereby obtaining a trained ML model; and storing the trained ML model.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 illustrates a monitoring system embodiment under the present disclosure;

FIGS. 2 illustrates a possible user interface embodiment for a monitoring system under the present disclosure;

FIGS. 3 illustrates a possible user interface embodiment for a monitoring system under the present disclosure;

FIGS. 4 illustrates a possible user interface embodiment for a monitoring system under the present disclosure;

FIGS. 5 illustrates a possible user interface embodiment for a monitoring system under the present disclosure;

FIGS. 6 illustrates a possible user interface embodiment for a monitoring system under the present disclosure;

FIGS. 7 illustrates a possible user interface embodiment for a monitoring system under the present disclosure;

FIGS. 8 illustrates a possible user interface embodiment for a monitoring system under the present disclosure;

FIGS. 9 illustrates a possible user interface embodiment for a monitoring system under the present disclosure;

FIGS. 10 illustrates a possible user interface embodiment for a monitoring system under the present disclosure;

FIGS. 11 illustrates a possible user interface embodiment for a monitoring system under the present disclosure;

FIGS. 12 illustrates a possible user interface embodiment for a monitoring system under the present disclosure;

FIGS. 13 illustrates a possible user interface embodiment for a monitoring system under the present disclosure;

FIGS. 14 illustrates a possible user interface embodiment for a monitoring system under the present disclosure;

FIG. 15 illustrates a monitoring system embodiment under the present disclosure;

FIG. 16 illustrates a flow-chart of a method embodiment under the present disclosure;

FIGS. 17 illustrates a possible user interface embodiment under the present disclosure;

FIGS. 18 illustrates a possible user interface embodiment under the present disclosure;

FIG. 19 illustrates a possible computing device, server, database, or monitoring system embodiments under the present disclosure;

FIG. 20 illustrates training and inference pipeline embodiments under the present disclosure;

FIG. 21 illustrates a neural network embodiment under the present disclosure;

FIG. 22 illustrates a flow-chart of a method embodiment under the present disclosure;

FIG. 23 illustrates a flow-chart of a method embodiment under the present disclosure; and

FIG. 24 illustrates a flow-chart of a method embodiment under the present disclosure.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

There currently exist certain challenges in the art of digital marketing campaign auditing and associated website code maintenance and auditing. Various versions of a company's website may need to comply various digital marketing campaigns, or with different laws, such as privacy laws. In addition, there may also be a number of different data collection platforms integrated with various website versions. Examples of marketing/data platforms include Google Analytics, Facebook, Amazon Ads, DV360, and others. It is time consuming for website managers to access, e.g., 50 different website versions and ensure correct implementation of marketing campaigns, and/or data or legal compliance across all website versions. In the prior art, an administrator had to login to separate marketing campaign/platforms (e.g., Google Ads) and check compliance and functionality of various webpages separately. There has not been a central platform to ascertain marketing campaign implementation or data collection and legal compliance across multiple websites and marketing platforms simultaneously.

Certain aspects of the disclosure and their embodiments may provide solutions to these or other challenges. Embodiments under the present disclosure include platforms, systems, and methods that audit and compare multiple marketing and analytics platforms along with analyzing performance metrics across multiple sites. Tools, like Google Analytics, DV360, CM360, FB (or X), Amazon Ads, etc., are evaluated for proper deployment across multiple sites at scale against best practices and company policies.

Certain embodiments may provide one or more of the following technical advantages. Embodiment can save time, allowing managers to ensure compliance across multiple sites quickly via a single dashboard. Data collected can also improve marketing or website practices for better sales, more page views, and/or other optimized or maximized data or results. Embodiments can simplify the complex tracking, auditing and compliance needs for global advertisers, delivering ROAS visibility, media transparency, and data governance management in one easy-to-use platform.

Some of the embodiments contemplated herein will now be described more fully with reference to the accompanying drawings. Embodiments, which may in some cases be referred to generally as a monitoring platform, are provided by way of example to convey the scope of the subject matter to those skilled in the art.

Monitoring platform embodiments under the present disclosure can comprise systems, methods, and platforms that audit and compare digital marketing campaign settings from multiple marketing and analytics platforms along with analyzing performance metrics across multiple sites. Tools, like Google Analytics, DV360, CM360, FM (or X), Amazon Ads, etc., can be evaluated for proper deployment across multiple sites at scale against best practices and company policies. Misconfigurations due to human error or lack of knowledge can significantly impact these metrics—something that certain embodiments under the present disclosure can help alleviate.

A monitoring platform dashboard can interface with a company's existing analytics and marketing platforms, allowing managers to review and compare configurations of different platforms. It can automatically check for compliance with marketing campaigns across multiple platforms, ensuring corporate policies, best-use practices, and preferences, identify privacy and consent violations, and display this information in a simple easy-to-use report (or dashboard). This can be done alongside an aggregate score/audit for the platforms (e.g., scores or compliance issues tracked across multiple websites, multiple marketing campaigns, multiple marketing platforms, etc.) tracking standard user metrics such as impressions, CPM, and conversion rates for an accurate view/representation of how proper configuration of these marketing and analytics platforms can directly impact performance.

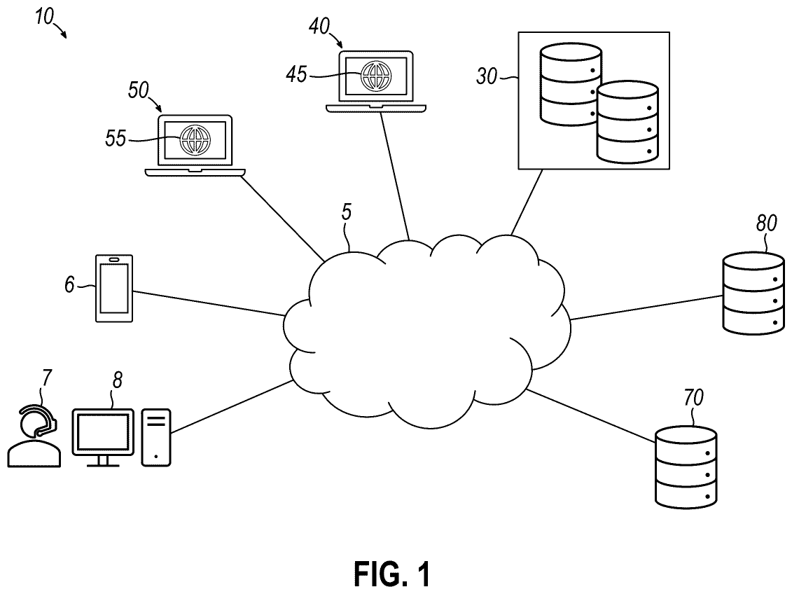

FIG. 1 illustrates a one example monitoring platform embodiment 10 under the present disclosure. Consumers may access websites 45, 55 via computing devices 40, 50 (e.g., computers, smartphones, etc.). Websites 45, 55 may be hosted on one or more servers 30. One or more advertising/marketing/other server(s) 70, 80 may be associated with a third-party marketing or other partner, e.g., Google Ads, Amazon Ads, DV360, etc. A company running websites 45, 55 may have implemented one or more marketing campaigns with such third-party marketing partners or may use such third parties to track website data, or perform other tasks. Each marketing partner may have tags, cookies, plug-ins, or other tools, implemented and integrated into websites 45, 55. These tools may, e.g.: display advertisements based on user preferences or browsing history, track consumer spending, track consumer time spent on certain portions of a webpage, and/or perform and/or collect a variety of tasks or metrics useful for measuring the effectiveness of marketing campaigns. User(s) 7 may utilize a computing device such as computer 8 or mobile device 6 to manage or edit websites 45, 55 by accessing code stored on server(s) 30. Network 5 may enable communication between e.g., user 7, servers 30, computer 40, 50, and marketing servers 70, 80. Network 5 may comprise the internet, cellular data networks, satellite networks, local area networks, enterprise networks, wireless networks, wired networks, other data networks, and/or combinations of any of the foregoing. While user 7, servers 30, and computer 40, 50 are shown remote from each other, any of these components and/or network 5 could be co-located at a location, e.g., a company's offices. User(s) 7 may edit, manipulate, manage, control, access, view, and otherwise interact with websites 45, 55 hosted on servers 30. User 7 may be manager, coder, developer or other personnel tasked with developing and managing the websites 45, 55. Websites 45, 55 may in some respects be considered the same website (e.g., companyx.com), but formatted or coded differently depending on various factors or variables. These variables could be, e.g., age of a consumer, state of the USA where a consumer is located, country where a consumer is located. citizenship of a consumer, or other variables. Servers 30 may detect these variables automatically (e.g., via a detected IP address) or may receive an input from a consumer (e.g., sign-in information including citizenship). Such variables may require or be predetermined by a company to be associated with a specific version of websites 45, 55. For example, consumers in the European Union are subject to GDPR (General Data Protection Regulation), or California residents are subject to CCPA (California Consumer Protection Act), or there may be a specific website version for children, or for blind or deaf consumers. In some situations, the company may partner with a certain marketing or ad partner (e.g., Google Ads™) in the United States, but with a different partner for China. In such situations, the website 45, 55 may be in different languages and formats for the United States versus China, and the website 45, 55 may interact with different plugins and APIs (application programming interfaces) for the given advertising partner. Systems and methods under the present disclosure can allow user(s) 7 to view and audit website compliance across all websites 45, 55. Server(s) 30 could be operated and run by the company owning the website, or they could be hosted on third-party servers, or combinations of the foregoing. In some embodiments, websites 45, 55 may comprise different brands, entities, subsidiaries under one parent company or brand, which monitoring platform 10 allows the parent company to monitor quickly and easily. It can be seen from the foregoing description, that a single parent company may operate various brands (each with their own unique website), and each brand may have different versions of a home page or a website. For example, a parent company may have brand-x.com and brand-y.com. Each brand may have various version of the underlying website. For example brand-x.com may have 20 different versions for different geographic regions around the world, an additional version for children (for each of the 20 geographic regions), an additional version for blind users (for each of the 20 geographic regions), multiple language versions for certain geographic regions, and other versions of brand-x.com. As such, just brand-x.com might have dozens of different versions, many implemented with different marketing or metrics platforms provided by third parties. Monitoring performance, marketing metrics, privacy compliance, and other factors, across all of these versions of brand-x.com and brand-y.com is onerous.

Portions of website 45, 55 and/or server(s) 30 may be associated with or communicate with marketing servers 70, 80 (or other types of advertising, online, or metrics tracking platforms). Marketing servers 70, 80 may be operated by a marketing or other commercial partner of the company running websites 45, 55. Marketing servers 70, 80 may comprise at least a portion of a marketing platform (e.g., GA4, Amazon Ads, etc.). Marketing servers 70, 80 (and/or the respective platform) may allow access by users (e.g. website administrators for websites 45, 55 via APIs, A user may set up a marketing campaign by implementing a variety of settings, advertisements, media, and other options by logging into a respective marketing platform and manually choosing options, uploading media, and other steps. Data collection options, naming conventions for websites and webpages, page view metrics, and other options may be set for a given marketing campaign. Different advertisements may be chosen for different websites, or different versions of the same webpage (e.g., English or Spanish language media for English or Spanish website versions). Different metrics/creatives can be chosen to be deployed to websites 45,55 and collected. As such, the platform can be used to put into action deployments to marketing campaigns and platforms, as well as collecting and measuring related to data collection for those same campaigns and platforms. Marketing platforms typically offer management APIs, for setting up marketing campaigns, and reporting/metrics APIs for accessing metrics and data collected for ascertaining results of marketing campaigns. As described below, embodiments of monitoring platforms under the present disclosure can access both management and reporting APIs for setting up marketing campaigns and for ascertaining and measuring outcomes and sales metrics. For example, data may be sent/received by Amazon Ads during consumer visits to websites 45, 55. Such data may involve ads, consumer data, consumer behavior, etc. Software comprising portions of computing devices 6, 8 and/or servers 30 can allow user 7 to set, adjust, edit, audit, and otherwise manipulate interactions between websites 45, 55 served by servers 30 and how they interact with marketing servers 70, 80. For example, certain data may be collected by website version 45 but not by website version 55 (e.g., because of a local regulation), and collection and sending of such data to marketing servers 70, 80 might need to be turned off for website version 55 served to computing device 50. Other examples are given below and will become clear in regard to other figures described herein illustrating the types of data and settings that may adjusted or audited.

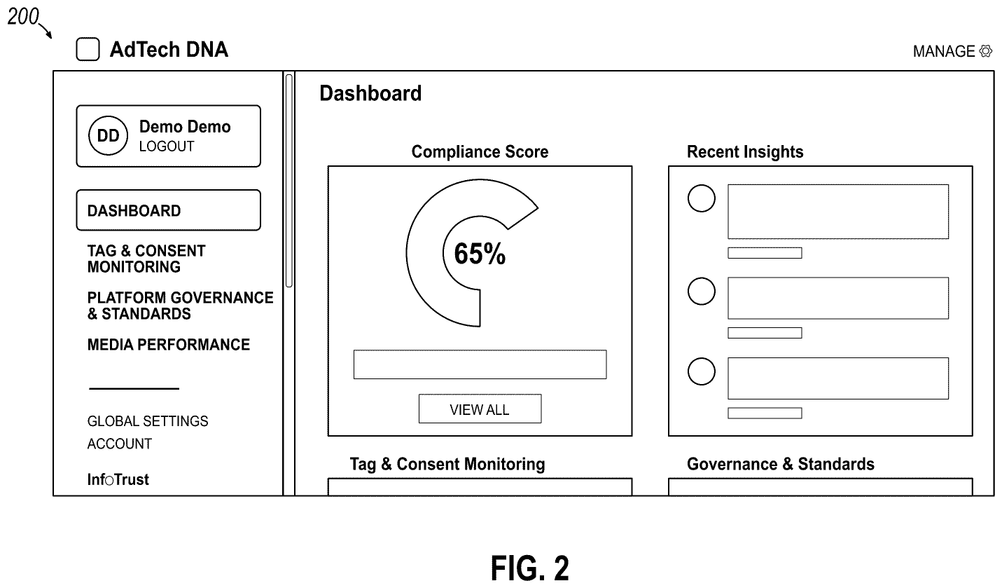

FIGS. 2-14 show various embodiments of a user interface offered e.g., to user(s) 7 on computing device 6, 8 interface with server(s) 30 to manage/audit/edit and otherwise control websites 45, 55.

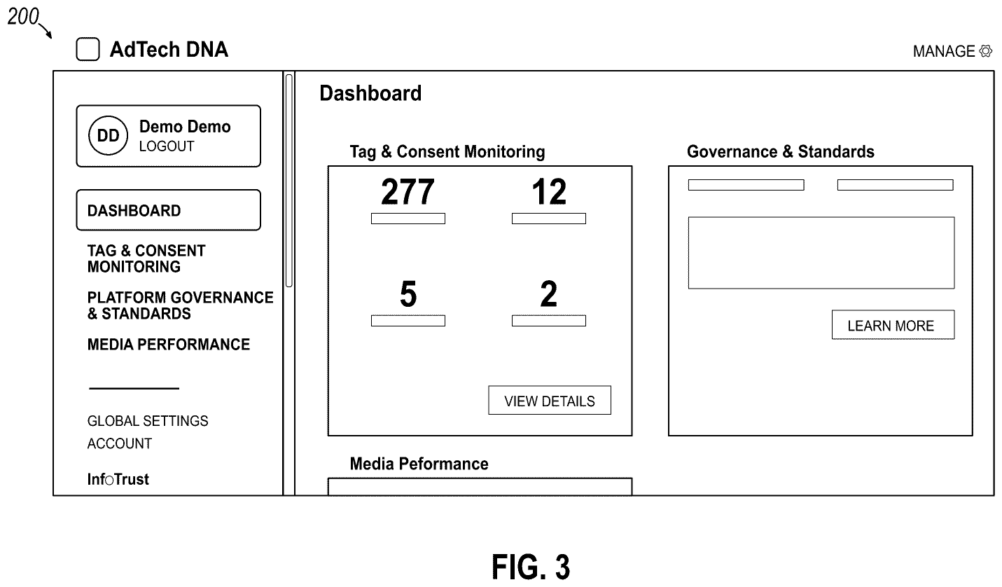

FIGS. 2 and 3 show a basic dashboard 200 view under certain embodiments. A user may choose the dashboard 200 or other views, such as tag and consent monitoring, platform governance and standards, or media performance, described further below. Dashboard 200 may show, e.g., a compliance score with recommendations, recent insights, and quick views of other portions of the platform, such as tag and consent monitoring or governance standards. Software comprising dashboard 200 and e.g., system 10 of FIG. 1, may continuously, or at set intervals, monitor one or more websites 45, 55 (which may be dozens or more different versions of the same underlying website or set of websites) and portions of websites 45, 55. Such software may also comprise an instance on e.g., server(s) 30 in a cloud-based embodiment, that user 7 at computing devices 6, 8 can log into. Monitored aspects may be e.g.: GDPR compliance for websites 45, 55 for EU consumers; CCPA compliance for websites 45, 55 for California consumers; consent by user statistics (e.g., consent to privacy policies); Google Ads settings for some or all websites 45, 55; Google Display & Video 360 (DV360) settings for some or all websites 45, 55; Meta Ads settings for some or all websites 45, 55; etc. In prior art systems, a user or manager would have to go into various dashboards and interfaces to perform all of these tasks, e.g., logging into a Meta Ads dashboard, a DV360 dashboard, and a website hosting interface and others, to audit all the settings that are important to monitor.

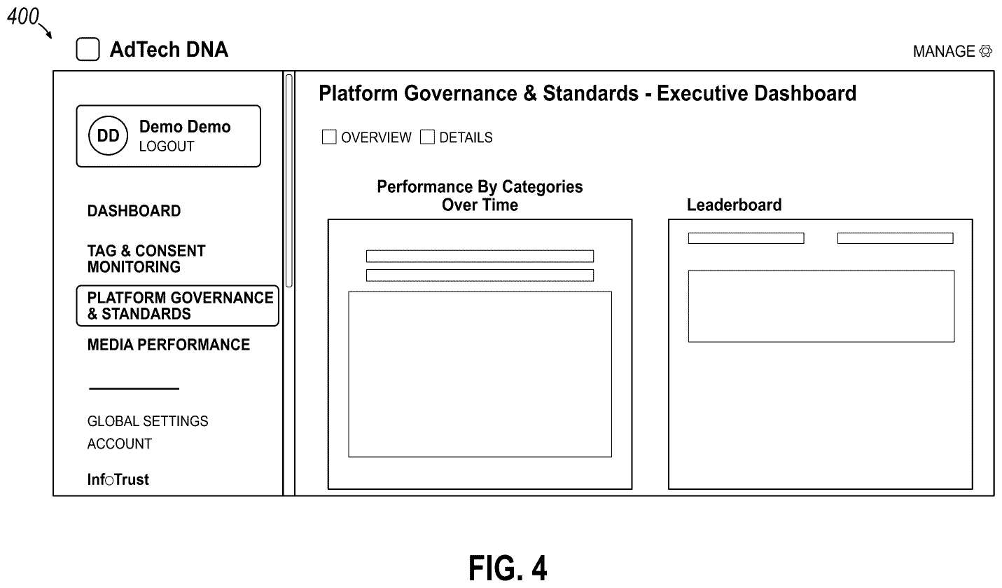

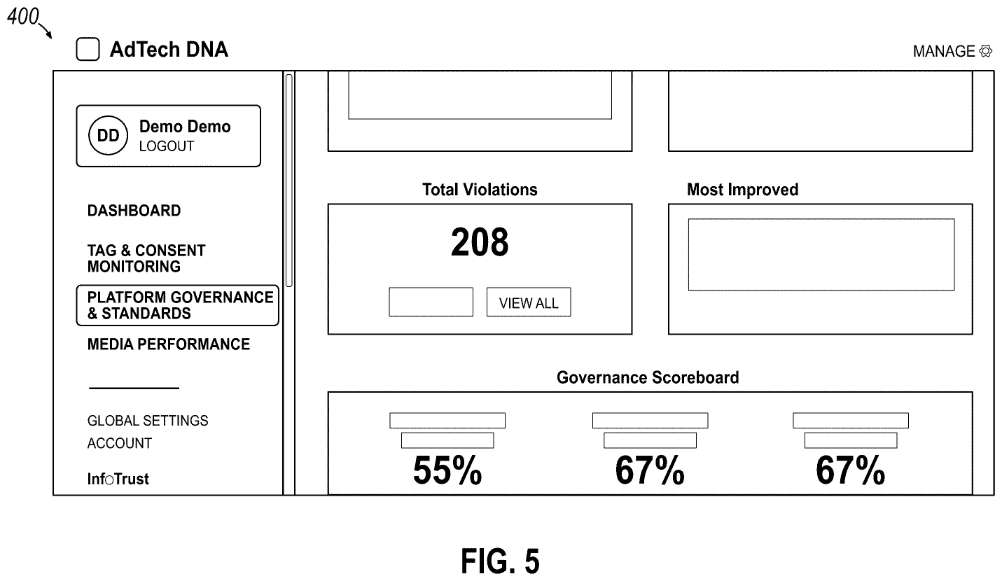

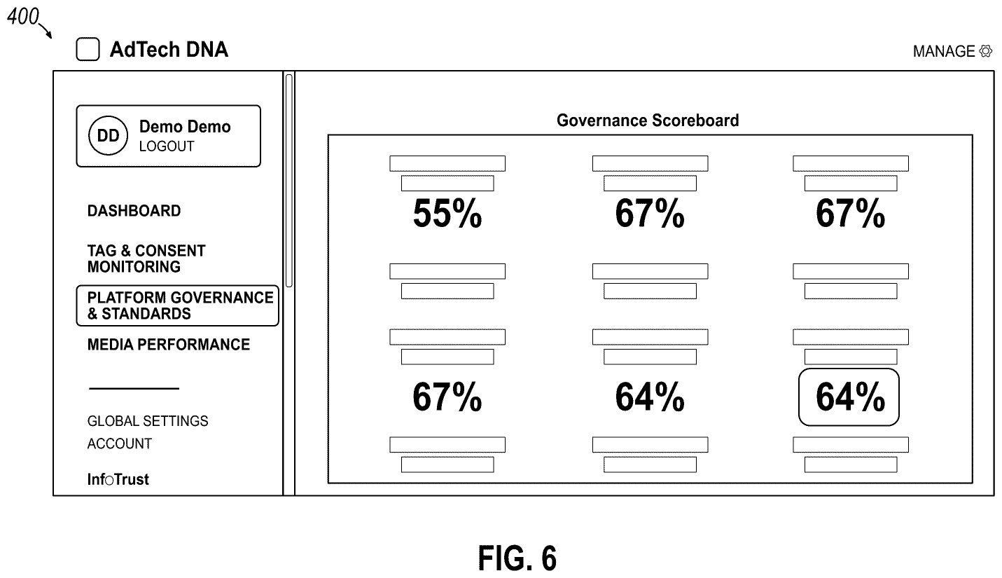

Clicking on platform governance and standards on the left-hand column or the quick view in dashboard 200 can bring the user to platform governance 400 view of FIGS. 4 to 8. Platform governance 400 can show, e.g., performance categories over time, in configurable areas such as media effectiveness, data quality, privacy, data enablement, tagging, and audiences. A leaderboard can be used to show the lowest or highest performers. This can show different versions of websites 45, 55 and compare their compliance scores, or different websites for different product lines all run by the same parent company. Other portions of platform governance 400 can show total violations across websites 45, 55, most improved, and governance scoreboards with compliance scores across different types of metrics, e.g., data quality, overview, or others, see FIGS. 5 and 6.

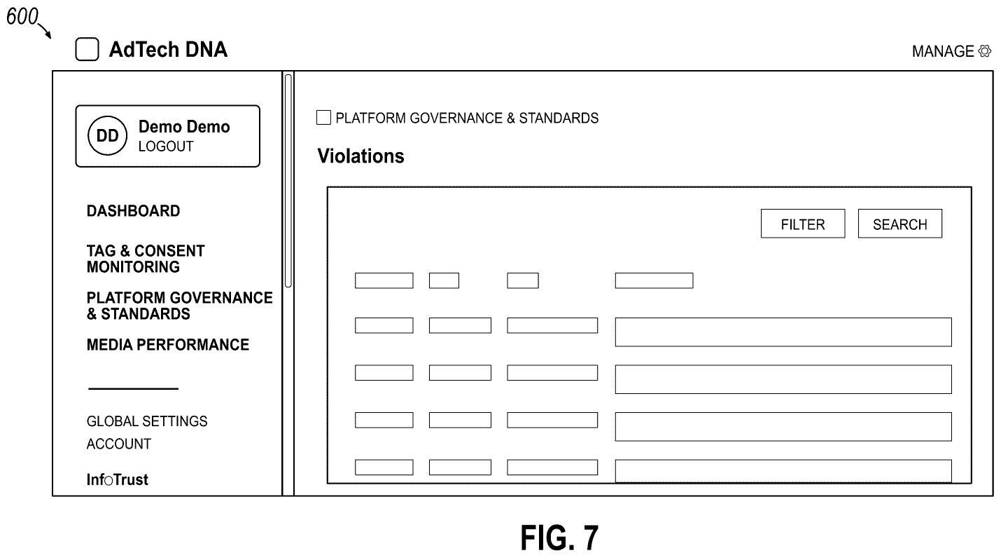

Clicking on “View All” under total violations on FIG. 5, or one of the “View Violations” in FIG. 6 can take a user to a view such as violations 600 of FIG. 7. Violations 600 can show policy violations, such as an Analytics platform is configured and/or if platforms are properly linked.

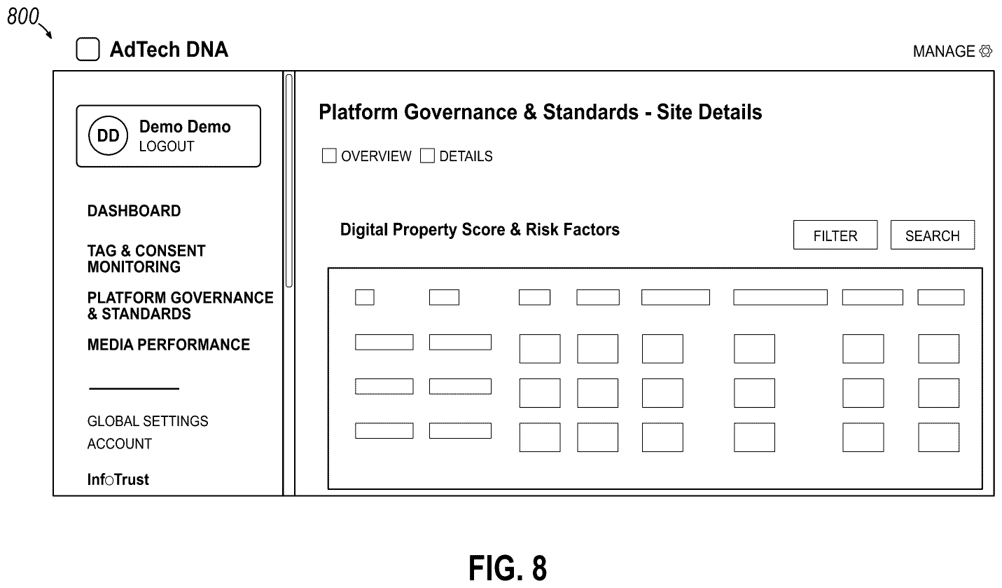

Clicking on “Details” in FIG. 4 can lead to e.g., the site details page 800 embodiment shown in FIG. 8. This page can show scores across several metrics or customizable enterprise standards (e.g., Analytics platform is configured and/or if platforms are properly linked) assigned to customized categories (e.g., media effectiveness, tagging, data quality, data enablement, audiences, privacy) for different websites or versions of websites (e.g., Nestle Baby, Nestle Purina, Nestle Kit Kat). The platform can allow for customizable rules across customizable categories to fit a user's needs.

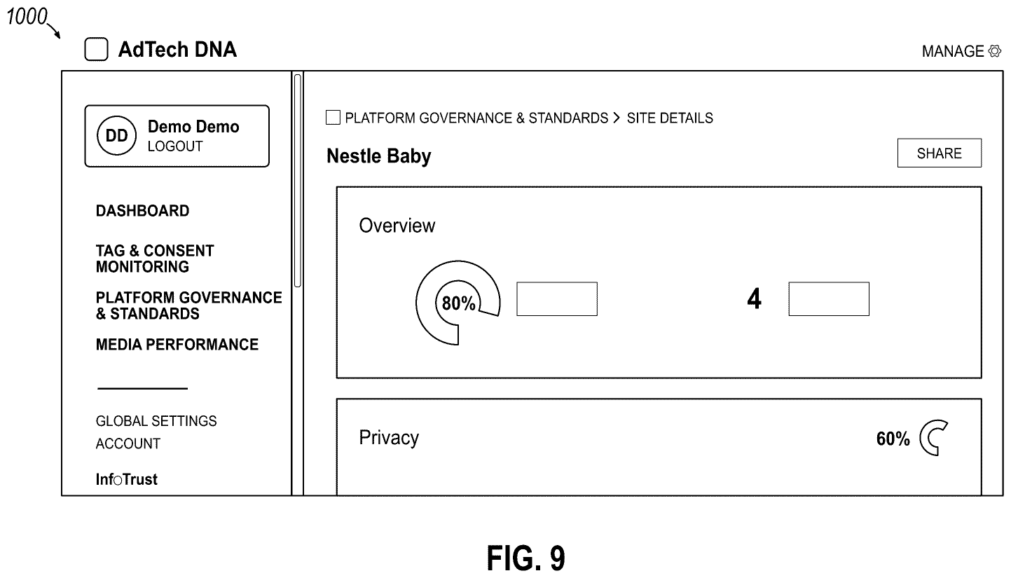

Clicking on one website/version (e.g., Nestle Baby) with site details page 800 can display e.g., website detail page 1000 embodiment of FIG. 9. Website detail page 1000 can show specific issues with the given website/version selected. Scrolling down website detail page 1000 can reveal various rules, measurements, flags, problems, issues, or other information related to various metrics or settings within a marketing platform/campaign (e.g., media effectiveness, tagging, data quality, data enablement, audiences, privacy).

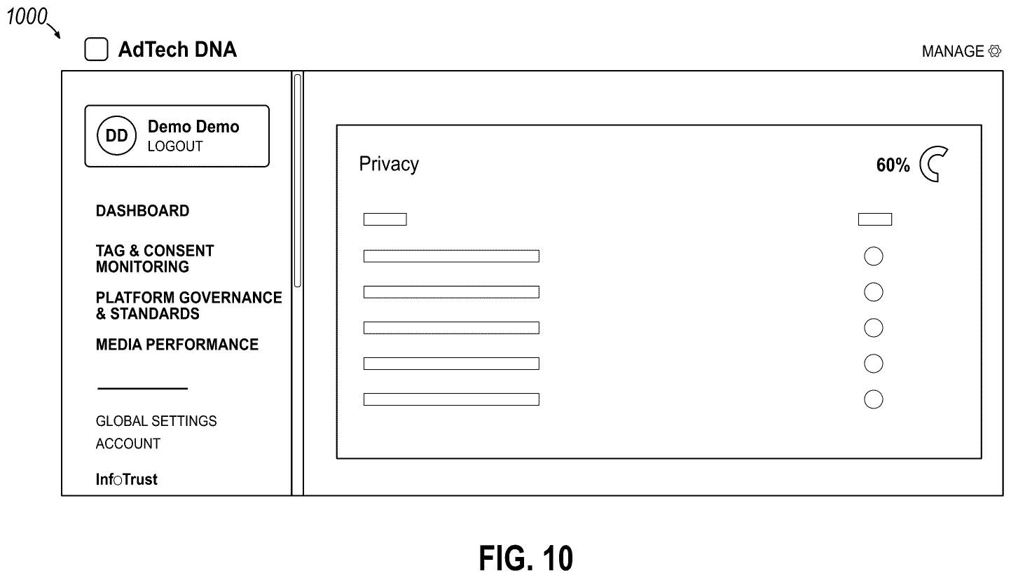

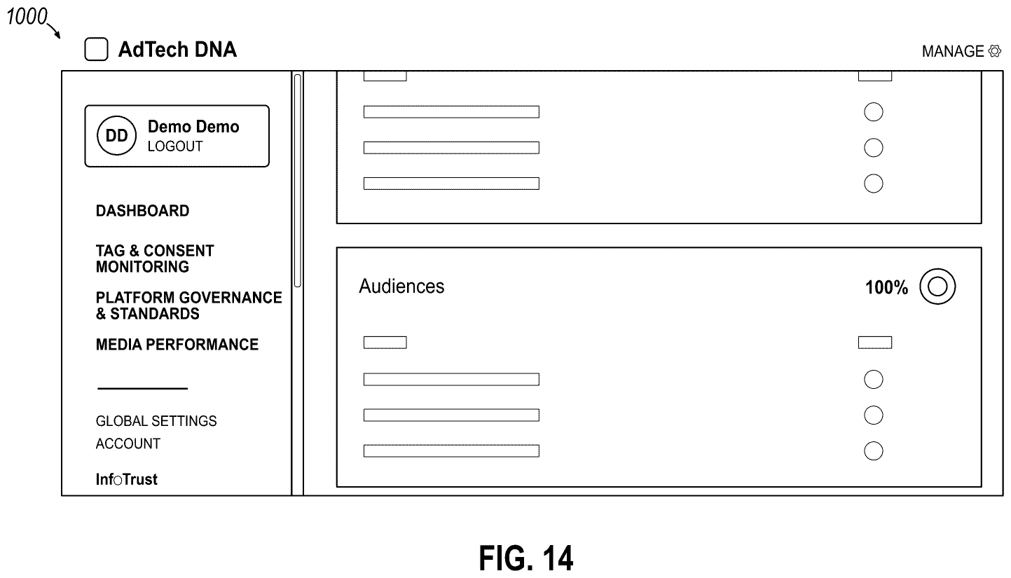

FIGS. 10 to 14 show various possible sections of website details page 1000. The groupings of each item shown on FIGS. 10 to 14 could change or use different terminology: data quality, tagging, privacy, etc. Each item listed (regardless of grouping), such as DV360 Allowed Access Check, GTM Allowed Access Check, Make sure web data stream exists, Ensure At Least 3 Custom Dimensions are Set, etc., can be checked by e.g., making an API call to the management APIs set up by the respective marketing partner for managing a given marketing campaign through that marketing partner. Each line item can generally be referred to as a rule or setting within a marketing platform/campaign. For example, DV360 refers to Display & Video 360, a system run by Google. A given website owner may have set up DV360 on all or a portion of its websites or webpages. In the prior art, to check whether DV360 is functional or set up correctly across various websites or webpages, the administrator would have to login to DV360 and manually check the settings. Under the present disclosure, an administrator can use a monitoring platform embodiment to check DV360 as well as other marketing platforms. For example, the line item DV360 Allowed Access Check can use the management API provided by DV360 and check that access is being permitted. GA4 (also a Google product) can also be accessed via management APIs. For example, as shown in FIG. 14, Check GA4 Property Naming Conventions can access the management API for Google Ads 4 and check that naming convention (preset by the administrator) are being implemented properly.

While FIGS. 10 to 14 are presented to show certain examples and embodiments of tracked rules or data, other movements are possible. In some embodiments the displayed rules may each be customizable by a user, such as a website administrator or marketing manager.

FIG. 10 shows privacy scores and flags. An overall privacy score can be displayed, as well as flagged issues. Scoring methods and flagged issues can be customizable by client/enterprise/website. Flagged issues could be e.g., DV360, GTM, or SA360 issues. Issues could be ensuring that autotagging is enabled, allowed access check, and others. As described above, The DV360 Allowed Access Check line item may reflect where the platform has called the management API for DV360 to ensure that access is enabled. Similarly, GTM allowed Access Check may reflect whether the platform has successfully called the GTM management API and performed an access check.

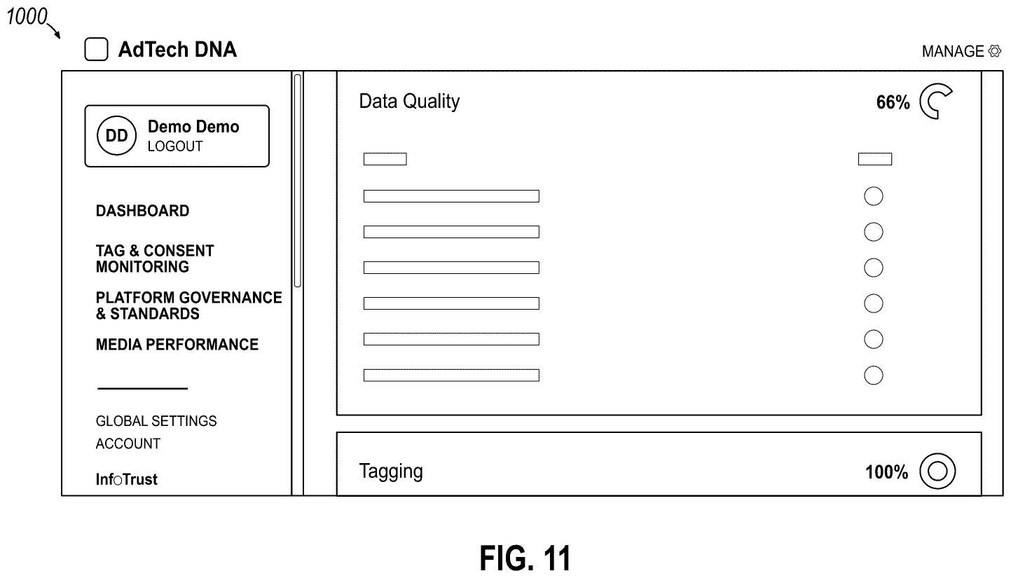

FIG. 11 shows data quality scores and flags. An overall data quality score can be displayed, as well as flagged issues. Flagged issues could be e.g., whether be data stream exists, whether GTM allowed access check, and others. The line items under Data Quality can check for different issues than the Privacy items, though still the platform is preferably checking these items through a management API to the respective marketing platform/campaign (e.g., DV360).

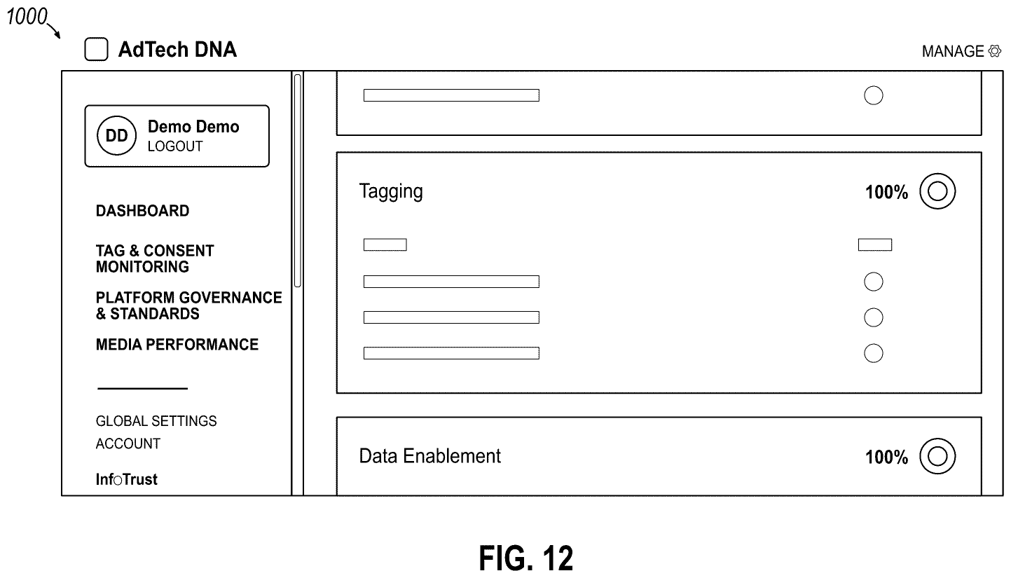

FIG. 12 shows tagging scores and flags. An overall tagging score can be displayed, as well as flagged issues. Flagged issues could be e.g., ensuring at least 3 custom dimensions are set, ensuring naming conventions, and others. Administrators can set custom dimensions or inquiries for the platform to check. Here for example, line items include Ensure At Least 3 Custom Dimensions Are Set (checking via a management API that at least 3 of the administrator's custom-created dimensions are correctly implemented) and Check GA4 Property Naming Conventions. GA4 allows users to set custom names for websites and webpages. Correctly checking these naming conventions may require custom-created inquiries or data checks within the platform.

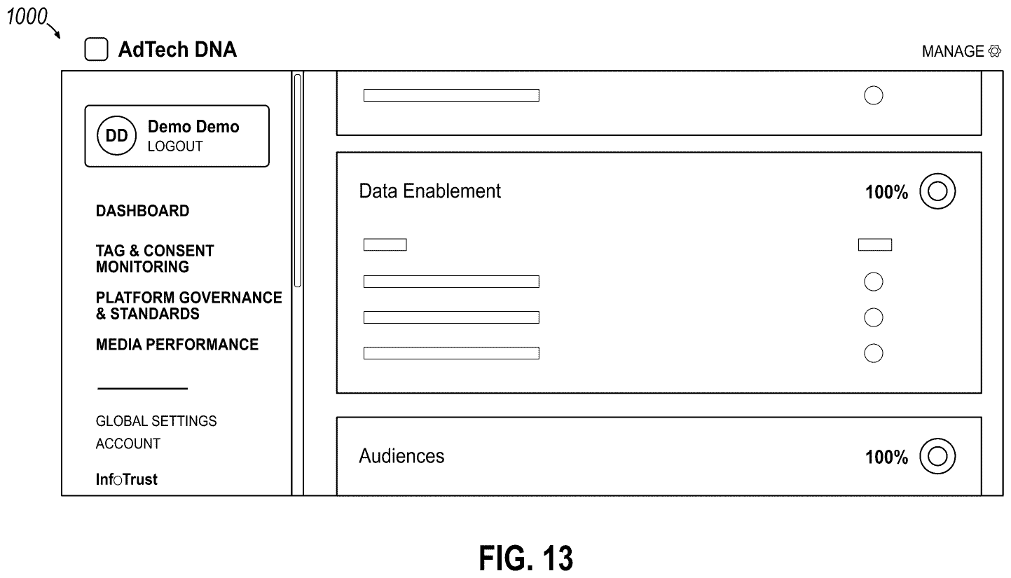

FIG. 13 shows data enablement scores and flags. An overall data enablement score can be displayed, as well as flagged issues. Flagged issues can be e.g., ensuring custom dimensions are set, ensuring stored custom dimensions exist, and others.

FIG. 14 shows audiences scores and flags. An overall audiences score can be displayed, as well as flagged issues. Flagged issues can be e.g., ensuring custom dimensions exist, ensuring property naming conventions, and others. As described above, the exact grouping of line items (e.g., Data Enablement, Privacy, etc.) can vary.

The various rules or line items shown in FIGS. 9-14 can perform a variety of checks on marketing platforms and marketing campaigns. Each rule can involve the platform periodically, at set intervals (e.g., daily, hourly, etc.), and/or on-demand, making an API call via management APIs to the respective marketing platform. These various status checks can ensure various factors, such as: are advertisements displaying correctly, are data streams performing correctly, are naming conventions correct, is the correct data being tracked, is the campaign functioning at all, etc. Different platforms (GA4, AmazonAds, Facebook Ads, etc.) may offer similar functionality, but there may exist some differences. Certain data could be virtually identical, but have a different title between different platforms, for example. The platform can be adjusted to harmonize data, status, naming, etc. amongst various platforms. The line items on FIGS. 9-14 typically involve a call to a management API of a marketing campaign/platform.

Various of the features of FIGS. 2 to 14 may be integrated with ticketing platforms. For example, the list of violations in FIG. 7 may be integrated so that each flagged violation automatically leads to a ticket item for an IT department to work on and correct. Integration could also lead to interface 600 of FIG. 7 reflecting that a flagged issue has been corrected once the ticket is completed.

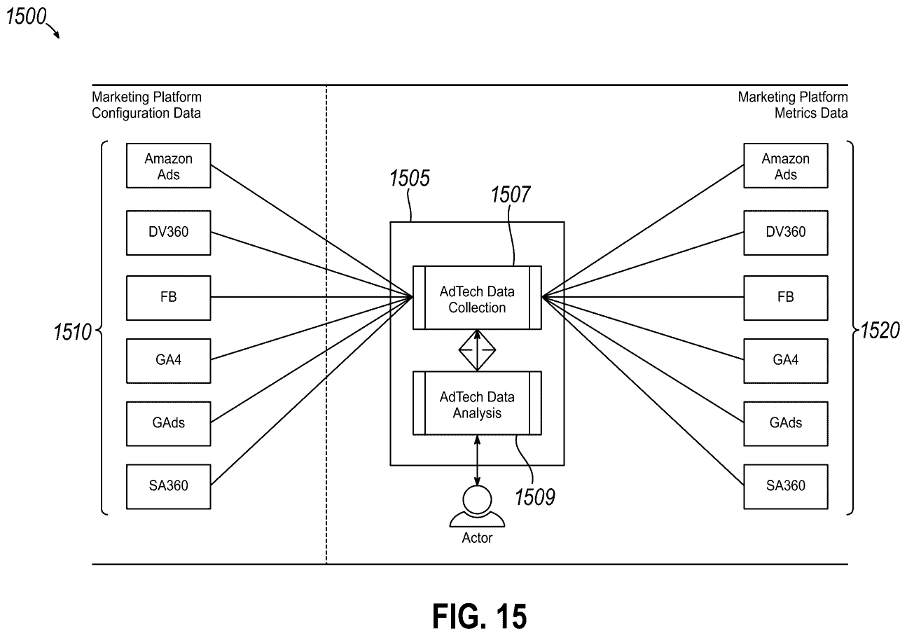

A monitoring platform under the present disclosure may present the user interface shown in FIGS. 2 to 14 to a user, such as a website administrator for the websites 45, 55 of FIG. 1. One embodiment of such a monitoring platform 1505 is shown in FIG. 15. Monitoring platform 1505 can comprise data collection module 1507 and data analysis module 1509 within a broader monitoring system 1500. Data collection module 1507 can collect/receive configuration data 1510 and metrics data 1520 from various marketing partners that are integrated with websites 45, 55 of FIG. 1. Marketing partners could include e.g., AmazonAds, DV360, FB, GA4, Meta, Gads, SA360, etc. Configuration data 1510 and/or metrics data 1520 can be accessed via e.g., APIs for each marketing platform. Configuration data is typically accessed via management APIs for the respective marketing campaign/platform. Metrics data is typically accessed via reporting or metrics APIs for the respective marketing campaign/platform, which are typically distinct from the management APIs. Reporting APIs may allow access to statistics such as: page views, sales outcomes, time spent viewing an advertisement, and other statistics Monitoring platform 1505 could be implemented in any of: one or more servers, one or more computing devices, one or more databases, or similar components, and/or in combinations of any of the foregoing. Monitoring platform 1505 could comprise e.g., portions of website server(s) 30 of FIG. 1 which present interfaces of FIGS. 2 to 14 to user 7 via computing devices 6, 8. Other arrangements are possible.

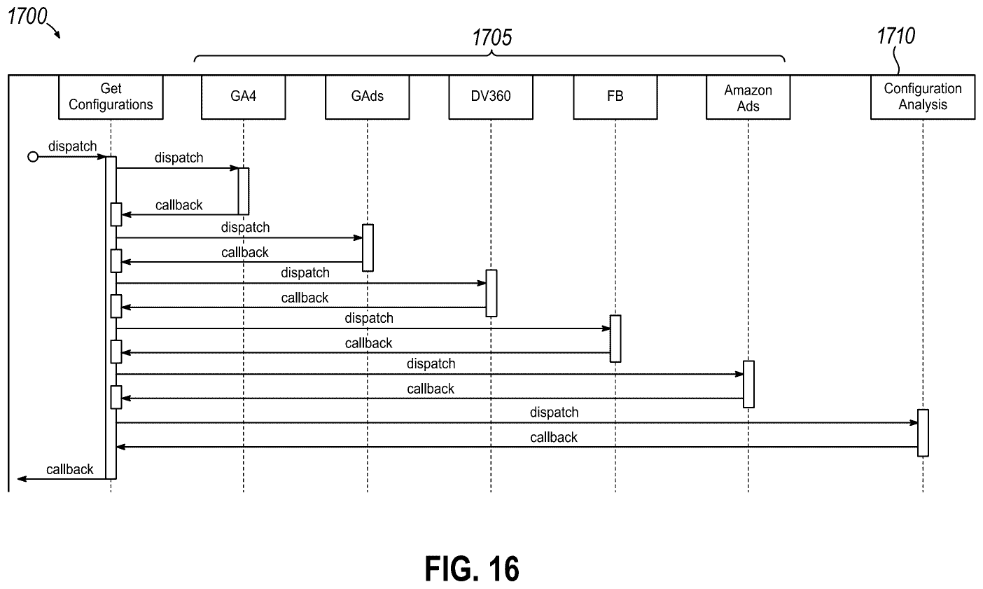

One possible flow chart of a data collection process performed by monitoring platform 1505 of FIG. 15 is shown in FIG. 16. Process/method 1700 illustrates a process of retrieving configurations for various marketing partners, but a similar process could be carried out to retrieve metrics from each marketing partner. At a first step, monitoring platform 1505 of FIG. 15 can be dispatched or begin the process 1700 at a request from e.g. a user/administrator. Process 1700 can comprise a dispatch or request to each marketing partner 1705. A dispatch/request is made to the marketing partner 1705 and a callback is made with the requested information (such as some of the information shown in FIGS. 2-14). Finally, a dispatch and callback can occur to a configuration analysis 1710, which can e.g., compute data such as the data shown in e.g., FIGS. 2-14 including the scores shown in FIGS. 10-14.

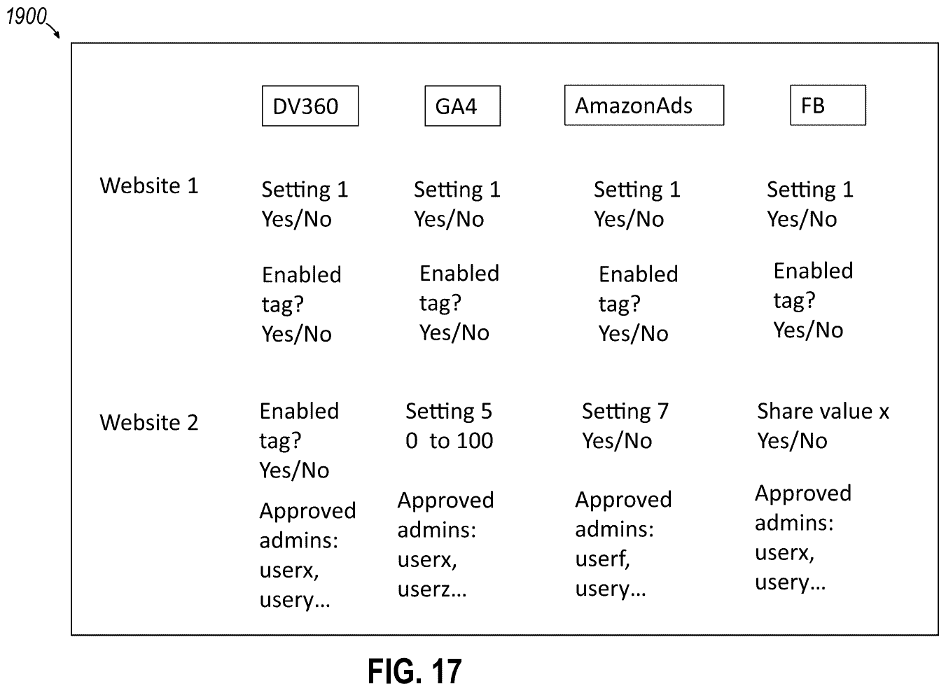

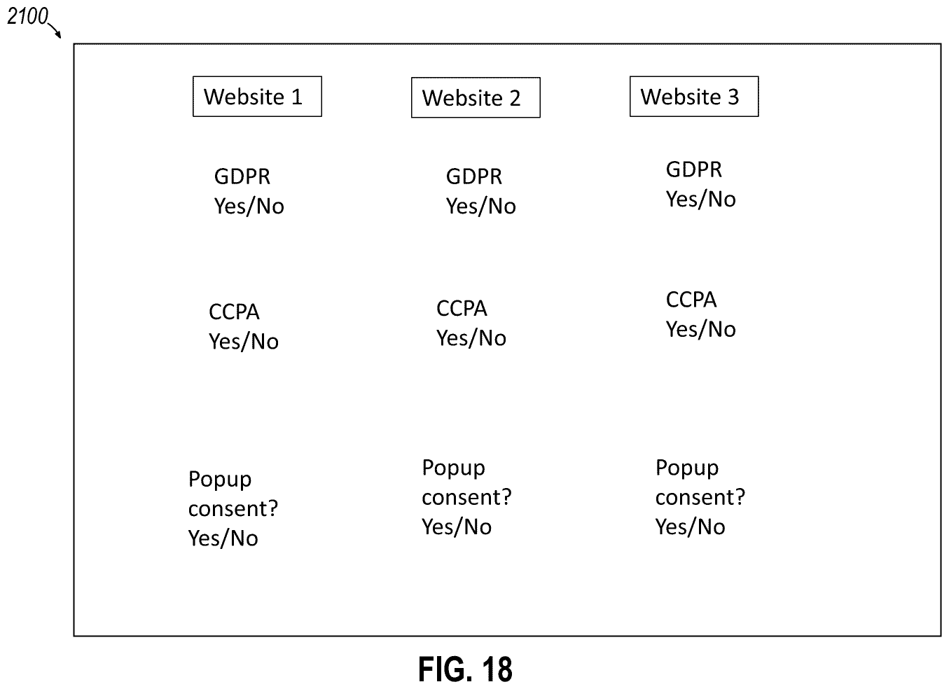

Prior to performing status checks, such as shown in the scores in FIGS. 9-14, a user (e.g., a website administrator) may configure settings manually by logging into each respective marketing platform (e.g., GA4, Amazon Ads, etc.) But in some embodiments under the present disclosure, the monitoring platform may allow configuration setting for marketing platforms and marketing campaigns via interfaces such as shown in FIGS. 17-18. As such, users can be allowed to change, fix, adjust, or otherwise manipulate various settings within marketing campaigns and platforms.

FIG. 17 shows a possible setting interface 1900 allowing a user/administrator to adjust settings for different digital marketing campaigns for different websites and associated marketing partners. In some cases, like with Website 1, a Setting1 may be present across multiple platforms. In some cases, like with Website 2, each marketing partner may have different settings. Approved editors or administrators can be chosen and set. Other arrangements and combinations of settings, enablement options, and other choices are possible.

Interface 1900 may be presented to a user/administrator before, during, and/or after the development of a website and/or integration with marketing campaigns and partners. This could be by e.g., clicking on global settings within interface 200 of FIG. 2. In some embodiments, an interface like interface 1900 may be presented to a user/administrator during an auditing process, such as in FIGS. 2 to 14, for a user/administrator to correct flagged issues.

Another possible interface for setting, adjusting, and/or correcting marketing campaigns and/or associated website settings is shown interface 2100 of FIG. 18. Here settings (such as, e.g., GDPR, CCPA, popup consent, etc.) can be monitored and/or corrected across multiple websites. Each website may be different websites run by a single entity, or could comprise multiple variations of the same website but for different audiences, e.g., USA, Europe, Mexico, etc.

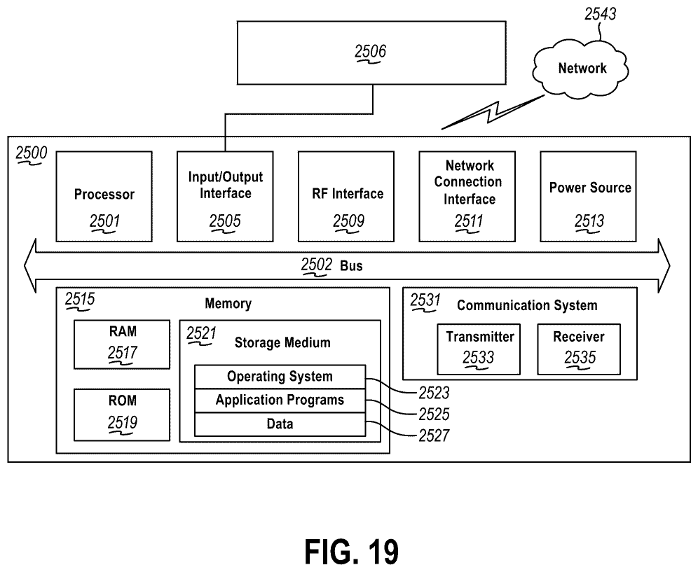

Monitoring platform 1505 of FIG. 15 can comprise at least a portion of, or be implemented across, multiple computing devices, servers, and/or databases, such as computing devices 6, 8 and website servers 30 of FIG. 1. FIG. 19 illustrates a possible computing device 2500 embodiment, which can comprise monitoring platform 1505 of FIG. 15, computing devices 6, 8, website servers 30, or other components comprising any of the foregoing under the present disclosure. Computing device 2500 can be used to perform, analyze, and/or optimize e.g., the functionalities described with respect to e.g., monitoring platform 1505 of FIG. 15, computing devices, servers, and/or databases, such as computing devices 6, 8 and website servers 30. System 2500 may comprise portions of, or be implemented across, one or more of the foregoing in various embodiments. System 2500 can perform the various method embodiments described herein, including machine learning embodiments as described further below.

Computing device 2500 includes processor 2501 that is operatively coupled via a bus 2502 to an input/output interface 2505, a power source 2513, a memory 2515, a RF interface 2509, network communication interface 2511, and/or any other component, or any combination thereof. The level of integration between the components may vary from one embodiment to another. Further, certain computing devices 2500 (or components thereof) may contain multiple instances of a component, such as multiple processors, memories, transceivers, transmitters, receivers, etc.

The processor 2501 is configured to process instructions and data and may be configured to implement any sequential state machine operative to execute instructions stored as machine-readable computer programs in memory 2515. Processor 2501 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processor 2501 may include multiple central processing units (CPUs).

In the example, input/output interface 2505 may be configured to provide an interface or interfaces to an input/output device(s) 2506, such as a screen, keyboard, indicator light, keypad, touchscreen, or other input or output device. Other examples of an output device include a speaker, a sound card, a video card, a display, a monitor, a printer, an actuator, an emitter, a smartcard, another output device, or any combination thereof. An input device may allow a user to capture information into system 2500. Other examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2513 is structured as a battery or battery pack. Other types of power sources, such as an external power source (e.g., an electricity outlet), photovoltaic device, or power cell, may be used. The power source 2513 may further include power circuitry for delivering power from the power source 2513 itself, and/or an external power source, to the various parts of computing device 2500 via input circuitry or an interface such as an electrical power cable.

Memory 2515 may be configured to include memory such as random-access memory (RAM) 2517, read-only memory (ROM) 2519, programmable read-only memory (PROM), erasable programmable read-only memory (EPROM), electrically erasable programmable read-only memory (EEPROM), magnetic disks, optical disks, hard disks, removable cartridges, flash drives, other storage medium 2521, and so forth. In one example, the memory 2515 includes one or more application programs 2525, an operating system 2523, web browser application, a widget, gadget engine, or other application, and corresponding data 2527. Memory 2515 may store, for use by the computing device 2500, any of a variety of various operating systems or combinations of operating systems. An article of manufacture, such as one including a simulation system or communication system may be tangibly embodied as or in memory 2515, which may be or comprise a device-readable storage medium.

Processor 2501 may be configured to communicate with an access network or other network using the RF interface 2509 or network connection interface 2511. The RF interface 2509 or network connection interface 2511 may comprise one or more communication subsystems and may include or be communicatively coupled to an antenna. In the illustrated embodiment, communication functions of the RF interface 2509 or network connection interface 2511 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof.

Certain embodiments can comprise and/or utilize machine learning insights for better compliance and artificial intelligence algorithms to suggest potential improvements for website or monitoring platform policies or marketing campaigns. For example, a ML model can take as inputs, e.g., types of violations shown in FIGS. 2 to 14, website settings, specific advertisements or marketing techniques, marketing platform settings, administrator identities, marketing partner identities, or other inputs, and seek to optimize outputs such as: ROAS, Conversion rates, Clicks, Impressions, and/or other outputs. Embodiments can include or utilize various types of artificial intelligence (AI) or ML, including e.g., supervised learning, reinforcement learning, and/or unsupervised learning. In certain embodiments, the monitoring platform can track marketing campaign/platform settings (e.g., a group of settings within GA4) and marketing outcomes (e.g., Conversion rates, Clicks, Impressions, or views depending on a referral source website, or other outcomes). Over time, and with training, the monitoring platform may learn which marketing campaign/platform settings perform better. Some embodiments may compare outcomes across different campaigns/platforms (e.g., GA4 vs Amazon Ads). Cross platform comparisons may in some embodiments require data harmonization to make data easier to compare. For example, one platform may measure page views per minute, but another platform may track views per second. Cross platform comparisons may necessitate converting data to another format so that proper comparisons are made. Certain monitoring platform embodiments may present prescriptive techniques to users on how best to implement a marketing campaign, such as: best advertisements or media to use, where to put them in a website, what marketing platforms perform best, what data collection techniques are most valuable, or a variety of other outcomes that may be useful for judging and improving marketing campaigns and marketing platform usage.

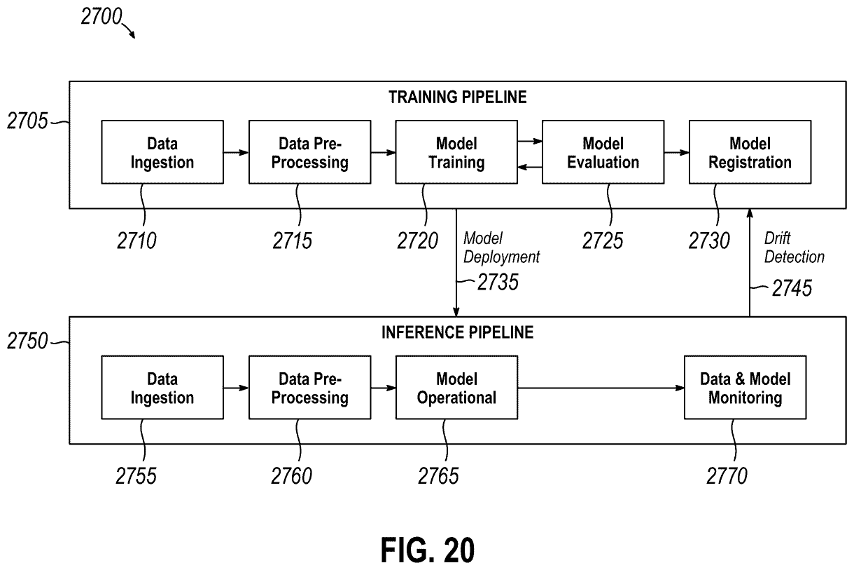

FIG. 20 illustrates one possible embodiment of training 2705 and inference 2750 pipelines as part of a model lifecycle 2700 that could be implemented in e.g., monitoring platform 1505 or computing device 2500. The model lifecycle 2700 comprises two pipelines: a training pipeline 2705 and an inference pipeline 2750.

At 2710 in the training pipeline 2705, data ingestion 2710 occurs, which includes gathering raw (training) data from a data storage. After data ingestion 2710, there may also be a step that controls the validity of the gathered data. At 2715 data pre-processing occurs, which can include feature engineering applied to the gathered data. This may involve, e.g., data normalization or data formatting or transformation required for the input data to the AI/ML model. After the ML model's architecture is fixed, it should be trained on one or more datasets. At 2720 model training is performed in which the AI/ML model is trained with the raw training data. To achieve good performance during live operation in a system (the inference phase), the training datasets should be representative of actual data the ML model will encounter during live operation. The training process often involves numerically tuning the ML model's trainable parameters (e.g., the weights and biases of the underlying neural network (NN)) to minimize a loss function on the training datasets. The loss function may be, for example, based on a maximum/minimum spend on marketing, sales total, page view totals, a maximum/minimum speed of performing a task, or other output. The purpose of the loss function is to meaningfully quantify the reconstruction error for the particular use case at hand. At 2725 model evaluation can be performed where the performance is benchmarked to some baseline. Model training 2720 and evaluation 2725 can be iterated until an acceptable level of performance is achieved. At 2730 model registration occurs, in which the AI/ML model is registered with any corresponding data on how the AI/ML model was developed, and e.g., AI/ML model evaluation data. At 2735 model deployment occurs, wherein the trained/re-trained AI/ML model is implemented in the inference pipeline 2750.

Data ingestion 2755 in the inference pipeline 2750 refers to gathering raw (inference) data from a data source. Data pre-processing 2760 can be essentially identical/similar to the data pre-processing 2715 of the training pipeline 2705. At 2765, the operational model received from the training pipeline 2705 is used to process new data received during operation of e.g., inventory system 50 of FIG. 1 or components thereof. At 2770 data and model monitoring is performed. Here the inference data is analyzed to determine whether the inference data are from a distribution that aligns with the training data, as well as monitoring model outputs for detecting any performance, or operational, variance or drifts. The variance or drift is used at 2745 (drift detection) to update the AI/ML model registration.

The training process can be based on some variant of a gradient descent algorithm, which can comprise e.g., a feedforward step, a back propagation step, and a parameter optimization step. These steps can be described using a dense ML model (i.e., a dense NN with a bottleneck layer) as an example.

If feedforward is used, then a batch of training data, such as a mini-batch, (e.g., several downlink-channel estimates) can be pushed through the ML model, from the input to the output. The loss function is used to compute the reconstruction loss for all training samples in the batch. The reconstruction loss may be an average reconstruction loss for all training samples in the batch.

If back propagation (BP) is used, then gradients (partial derivatives of the loss function, L, with respect to each trainable parameter in the ML model) can be computed. The back propagation algorithm sequentially works backwards from the ML model output, layer-by-layer, back through the ML model to the input. The back propagation algorithm is built around the chain rule for differentiation: When computing the gradients for layer n in the ML model, it uses the gradients for layer n+1.

If parameter optimization is used, then gradients computed in the back propagation step are used to update the ML model's trainable parameters.

It is preferred to make small adjustments to each parameter with the aim of reducing the average loss over the (mini) batch. It is common to use special optimizers to update the ML model's trainable parameters using gradient information. The following optimizers are widely used to reduce training time and improve overall performance: adaptive sub-gradient methods (AdaGrad), RMSProp, and adaptive moment estimation (ADAM).

In certain embodiments, the above process (feedforward, back propagation, parameter optimization) can be repeated many times until an acceptable level of performance is achieved on the training dataset. An acceptable level of performance may refer to the ML model achieving a pre-defined average reconstruction error over the training dataset (e.g., normalized MSE of the reconstruction error over the training dataset is less than, say, 0.1). Alternatively, it may refer to the ML model achieving a pre-defined value chosen by a user.

In some implementations, a function F(⋅) may be generated by a ML process, such as, for example, supervised learning, reinforcement learning, and/or unsupervised learning. It should further be understood that supervised learning may be done in various ways, such as, for example, using random forests, support vector machines, neural networks, and the like. By way of non-limiting example, any of the following types of neural networks that may be utilized, including, deep neural networks (DNNs), convolutional neural networks (CNNs), and recurrent neural networks (RNNs), or any other known or future neural network that satisfies the needs of the system. In an implementation using supervised learning the neural networks may be integrated into the hardware described in monitoring platform 1505 of FIG. 15 or computing device 2500 of FIG. 19 (e.g., in the form of simple vector-matrix multiplications).

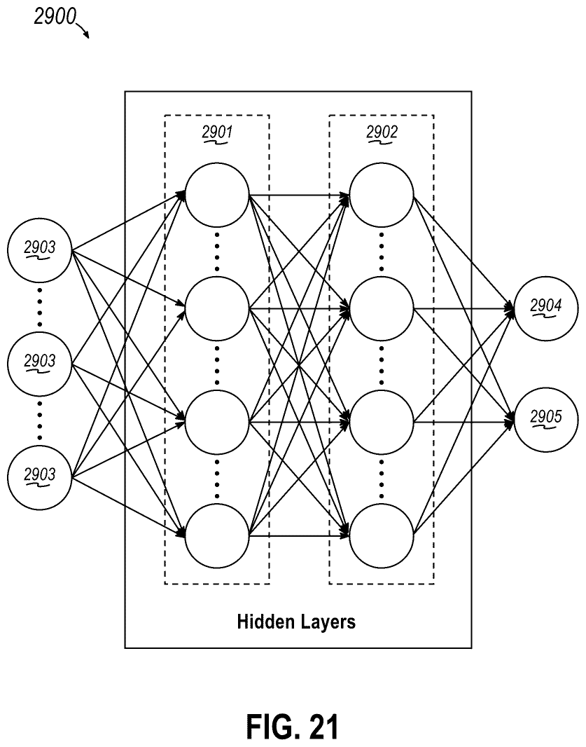

Referring now to FIG. 21, an example NN 2900 (e.g., DNN) is shown. In some implementations, and as shown, the neural network 2900 may include two hidden layers represented by dashed boxes 2901 and 2902. In certain implementations, the inputs 2903 may be fed into the NN 2900. Next, the inputs 2903 may go through a set of hidden layers (e.g., 2901 and/or 2902). Once the inputs 2903 pass though the hidden layers 2901 and/or 2902, they may be output (e.g., as an output layer) as e.g., website views 2904; cost of website maintenance 2905; or another output valuable for e.g., compliance metrics or scores, commercial sales, etc. Possible inputs can include e.g.: marketing partner name, administrator name, tag enablement metrics, privacy settings, and a variety of other factors.

As should be understood by one of ordinary skill in the art, in order for the NN 2900 to output a proper analysis for e.g., supervised learning, it should be trained properly (e.g., with a collection of samples) to accurately extract the likelihood values. If not trained properly, overfitting (e.g., when the NN memorizes the structure of the preambles but is unable to generalize to unseen preamble characteristics) or underfitting (e.g., when the NN is unable to learn a proper function even on the data that it was trained on) may happen. Thus, implementations may exist that prevent overfitting or underfitting, involving a set of well-engineered features that must be extracted from the preamble characteristics.

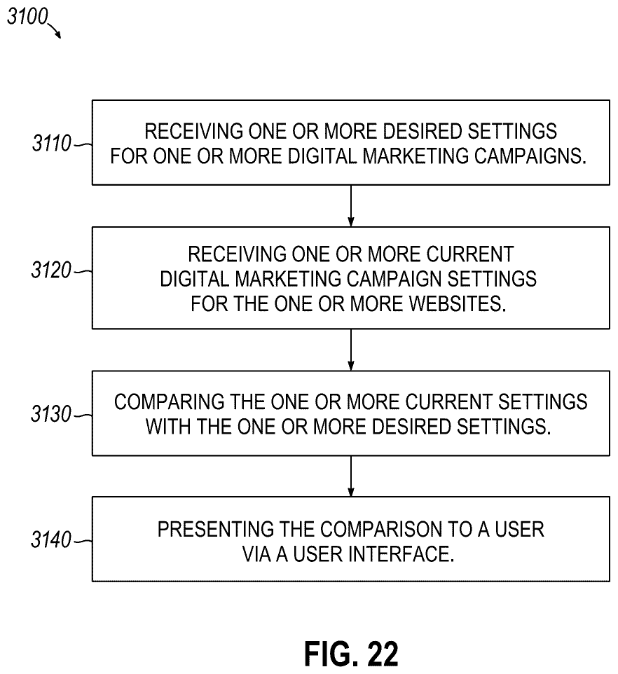

A possible method embodiment under the present disclosure is shown in FIG. 22. Method 3100 comprises a computer-implemented method for monitoring one or more digital marketing campaigns and their integration with one or more websites. Step 3110 is receiving one or more desired settings for one or more digital marketing campaigns. Step 3120 is receiving one or more current digital marketing campaign settings for the one or more websites. Step 3130 is comparing the one or more current settings with the one or more desired settings. Step 3140 is presenting the comparison to a user via a user interface. Method 3100 can comprise a variety of additional or alternative steps. In some embodiments any of the described steps can be optional.

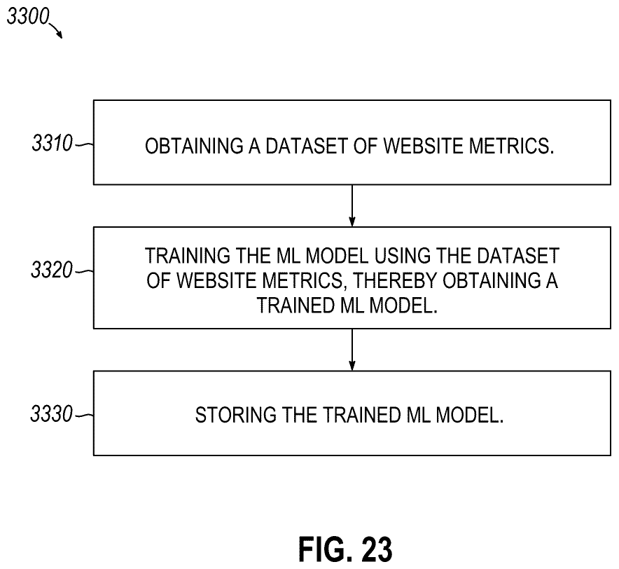

Another possible method embodiment under the present disclosure is shown in FIG. 23. Method 3300 comprises a computer implemented method for training a ML model for improving website performance. Step 3310 is obtaining a dataset of website metrics. Step 3320 is training the ML model using the dataset of website metrics, thereby obtaining a trained ML model. Step 3330 is storing the trained ML model. Method 3300 can comprise a variety of additional or alternative steps. For example, method 3300 could further include further training the ML model for optimizing website settings using a dataset of one or more identified website outcomes, thereby obtaining a further trained ML model. In some embodiments any of the described steps can be optional.

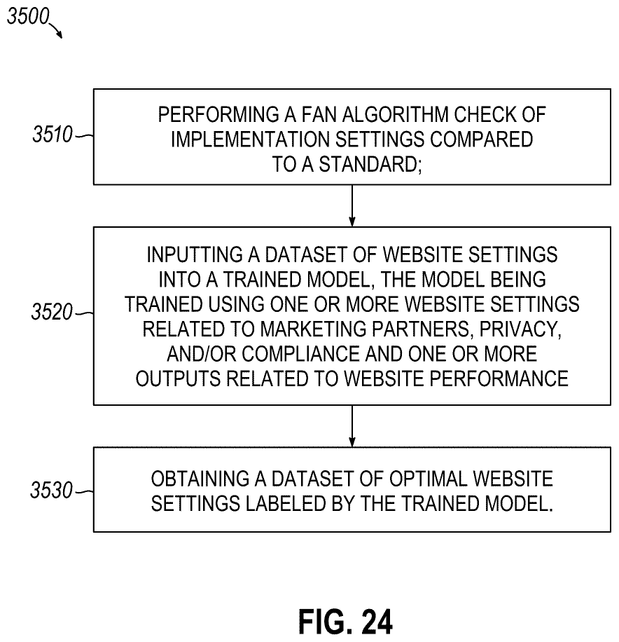

Another possible method embodiment under the present disclosure is shown in FIG. 24. Method 3500 comprises a computer implemented method for obtaining optimal website settings. Step 3510 is performing a fan algorithm check of implementation settings compared to a standard. Step 3520 is inputting a dataset of website settings into the trained machine learning model, the trained machine learning model being trained using one or more website settings related to one or more of: marketing partners, privacy, and/or compliance, and one or more outputs related to website performance. Step 3530 is obtaining a dataset of optimal website settings labeled by the trained model. Method 3500 can comprise a variety of additional or alternative steps. In some embodiments any of the described steps can be optional. In certain embodiments, any of the steps of method 3300 can be combined with any of the steps of method 3500.

Although the computing devices described herein (e.g., computers, tablets, smartphones, databases, servers, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

It will be appreciated that computer systems are increasingly taking on a wide variety of forms. In this description and in the claims, the terms “controller,” “computer system,” or “computing system” are defined broadly as including any device or system—or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor—as is the case if the executable component were binary. Alternatively, the structure may be structured to be interpretable and/or compiled—whether in a single stage or in multiple stages—so as to generate such binary that is directly interpretable by a processor.

The terms “component,” “service,” “engine,” “module,” “control,” “generator,” or the like may also be used in this description. As used in this description and in this case, these terms—whether expressed with or without a modifying clause—are also intended to be synonymous with the term “executable component” and thus also have a structure that is well understood by those of ordinary skill in the art of computing.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary embodiments may be implemented in hardware or special purpose chips, circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

While not all computing systems require a user interface, in some embodiments a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Conclusion

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by certain embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications, and variations may be effected to the particular embodiments by those of skill in the art without departing from the scope of the description, which is defined solely by the appended claims.

What is claimed is:

1. A computer-implemented method for monitoring one or more digital marketing campaigns and their integration with one or more websites, the method comprising:
receiving one or more desired settings for one or more digital marketing campaigns;
receiving one or more current digital marketing campaign settings for the one or more websites;
comparing the one or more current settings with the one or more desired settings; and
presenting the comparison to a user via a user interface.

2. The method of claim 1, wherein the one or more settings comprise at least one of: one or more privacy settings; one or more data settings; one or more marketing settings; one or more configuration settings; one or more language settings; one or more General Data Protection Regulation (GDPR) settings; one or more California Consumer Privacy Act (CCPA) settings.

3. The method of claim 1, further comprising receiving, from a user, one or more edits to the one or more current digital marketing campaign settings in response to the presenting.

4. The method of claim 1, wherein the one or more desired settings for one or more websites is received from one or more marketing partners of the one or more digital marketing campaigns.

5. The method of claim 1, wherein the one or more current settings for one or more digital marketing campaigns is received from one or more marketing partners of the one or more websites.

6. The method of claim 1, wherein the one or more websites comprise different versions of the same website for use in one or more different geographic areas.

7. The method of claim 1, further comprising issuing a ticket for any of the one or more current settings that do not match the one or more desired settings.

8. The method of claim 1, further comprising presenting compliance data over time to a user, wherein compliance refers to one or more scores given to comparisons of the one or more desired settings to the one or more current settings over time.

9. An apparatus for monitoring one or more digital marketing campaigns, comprising:
processing circuitry; and
a memory, the memory containing instructions executable by the processing circuitry whereby the apparatus is operative to perform the steps of:
receiving one or more desired settings for one or more digital marketing campaigns;
receiving one or more current digital marketing campaigns settings for the one or more websites;
comparing the one or more current settings with the one or more desired settings; and
presenting the comparison to a user via a user interface.

10. The apparatus of claim 9, wherein the one or more settings comprise at least one of: one or more privacy settings; one or more data settings; one or more marketing settings; one or more configuration settings; one or more language settings; one or more General Data Protection Regulation (GDPR) settings; one or more California Consumer Privacy Act (CCPA) settings.

11. The apparatus of claim 9, wherein the steps further comprise receiving, from a user, one or more edits to the one or more current digital marketing campaigns settings in response to the presenting.

12. The apparatus of claim 9, wherein the one or more desired settings for one or more digital marketing campaigns is received from one or more marketing partners of the one or more websites.

13. The apparatus of claim 9, wherein the one or more current settings for one or more digital marketing campaigns is received from one or more marketing partners of the one or more websites.

14. The apparatus of claim 9, wherein the one or more websites comprise different versions of the same website for use in one or more different geographic areas.

15. The apparatus of claim 9, wherein the steps further comprise issuing a ticket for any of the one or more current settings that do not match the one or more desired settings.

16. The apparatus of claim 9, wherein the steps further comprise presenting compliance data over time to a user, wherein compliance refers to one or more scores given to comparisons of the one or more desired settings to the one or more current settings over time.

17. A computer implemented method for obtaining optimal digital marketing campaigns settings, comprising:
obtaining a dataset of digital marketing campaign metrics;
training a machine learning model using the dataset of website metrics, thereby obtaining a trained machine learning model; and
storing the trained machine learning model.

18. The method of claim 17, further comprising:
performing a fan algorithm check of implementation settings compared to a standard;
inputting a dataset of digital marketing campaign settings into the trained machine learning model, the trained machine learning model being trained using one or more digital marketing campaign settings related to one or more of: marketing partners, privacy, and/or compliance, and one or more outputs related to website performance, and
obtaining a dataset of optimal digital marketing campaign settings labeled by the trained model.

19. The method of claim 17, wherein the machine learning model uses one or more inputs and produces one or more outputs;
wherein the one or more inputs comprises at least one of; types of violations, one or more digital marketing campaign settings, one or more specific advertisements, one or more marketing techniques, one or more marketing platform settings, one or more administrator identities, one or more marketing partner identities; and
wherein the one or more outputs comprise at least one of: return on advertising spending (ROAS); compliance with General Data Protection Regulation (GDPR); a conversion rate; a number of clicks; a number of impressions.

20. The method of claim 18, further comprising making a marketing recommendation to a user based on the dataset of optimal digital marketing campaign settings.
